(19) United States
(12) Patent Application Publication
(10) Pub. No.: US 2017/0257722 A1
(43) Pub. Date: Sep. 7, 2017

(54) APPARATUS AND METHOD FOR DETERMINING DELAY AND GAIN PARAMETERS FOR CALIBRATING A MULTI CHANNEL AUDIO SYSTEM

(71) Applicant: THOMSON LICENSING, Issy les Moulineaux (FR)

(72) Inventors: Michel KERDRANVAT, Chantepie (FR); Christophe COCAULT, Cesson-Sevigne (FR)

(21) Appl. No.: 15/447,137

(22) Filed: Mar. 2, 2017

(30) Foreign Application Priority Data
Mar. 3, 2016 (EP) 16305244.2

(51) Int. Cl. H04S 7/00; H04S 3/00

(52) U.S. Cl. CPC H04S 7/301; H04S 3/002; H04S 2400/13

(57) ABSTRACT

A method and an apparatus for adjusting delay and gain parameters for calibrating a multichannel audio system to which a plurality of loudspeakers is connected. A calibration process includes emitting a plurality of test tones by an audio processing device on a plurality of loudspeakers with predetermined timings and amplitude levels, according to a calibration signal. A calibration device having a microphone captures the audio signal corresponding to the test tones from the listener's position. The captured audio signal is analyzed, either by the calibration device or the audio processing device, to determine the delays between loudspeakers and difference of amplitude levels between loudspeakers. Corresponding delay and gain parameters are determined and used by the audio processing device to correct the sound to be played back. A calibration device and an audio processing device implementing the method are disclosed as well as a calibration signal utilized in the calibration process.

### REFERENCE TO RELATED EUROPEAN APPLICATION

This application claims priority from European Application No. 16305244.2, entitled “Apparatus and Method for Determining Delay and Gain Parameters for Calibrating a Multi Channel Audio System”, filed on Mar. 3, 2016, the contents of which are hereby incorporated by reference in its entirety

### TECHNICAL FIELD

The present disclosure relates to the calibration of multichannel audio systems and more precisely describes a method for determining the delay and gain parameters for calibrating a multichannel audio system with a plurality of loudspeakers.

### BACKGROUND

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A multichannel audio system is composed of an audio amplifier receiving an audio signal and a plurality of loudspeakers located at different places in the listening room, connected to the amplifier and allowing to render the sound. These systems became popular in households some years ago with the introduction of surround home theatre systems comprising an amplifier, a central loudspeaker, a loudspeaker positioned at the front left, a loudspeaker positioned at the front right, two loudspeakers positioned in the rear, behind the listener and one subwoofer loudspeaker dedicated to low frequencies that can be positioned almost anywhere in the room. The plurality of loudspeakers and their physical location deliver to the listener a feeling of spatial positioning of the sound. Such systems evolved towards more complex systems and in the near future it is considered to utilise much more loudspeakers, with the objective to reach a kind of three-dimensional sound allowing precise localization of the different sound sources.

Audio configurations are defined by the number of loudspeakers. A simple notation is used to identify the number and type of loudspeakers. In surround systems, the notation uses to digits separated by a point. A 2.1 system uses 2 loudspeakers at the front and one subwoofer. In more complex systems, three digits are used to identify the number of loudspeakers, the third digit indicates the number of elevated speakers. For example, the future American Television Society Committee (ATSC 3.0) standard will target 7.1.4 audio system to provide a real immersive audio environment which means 4 elevated speakers in addition to a 7.1 surround set-up. However sub-systems such as 5.1.4 or 5.1.2 are also possible.

However, in order to have a correct perception of the sound localisation, a so-called calibration phase is required to set the different calibration parameters for each loudspeaker. The first calibration parameter considered is the delay. When a first loudspeaker is quite close to the listener, he/she will receive the sound earlier than the sound coming from a second loudspeaker that is farther away. Indeed, in air the sound waves need about 3 ms to travel one meter. Differences of several milliseconds between loudspeakers are common in average listening rooms. Therefore, the delay for each loudspeaker needs to be set according to the distance to the listener so that the audio signal is perceived simultaneously from all loudspeakers at a listener position. A second parameter is the gain. Similar to the delay, the volume perceived by the user at the listener position is not homogeneous for all loudspeakers and depends on many parameters, including the distance but also the room configuration, the furniture in the room and materials of the walls, ceiling etc. that reflect some parts of the sound and absorb other parts. Therefore, the gain for each loudspeaker needs to be adjusted so that the audio signal is perceived homogeneously from all loudspeakers at the listener position. With this delay and gain calibrations, the multichannel audio system is able to achieve a well-balanced sound with maximal effects at the listener position often called the “sweet spot”.

A number of different solutions allow the calibration of multichannel audio systems. A common technique is based on playing back a test tone successively on each loudspeaker, record the signal at the listener position using a microphone connected to the amplifier and analyse the recorded signal to adjust gain and delay parameters to be applied for each loudspeaker. Since the microphone is physically connected to the amplifier, the determination of the delay is straightforward. The determining of the gain requires the knowledge of the transfer function of the microphone to measure the absolute sound pressure level produced by each loudspeaker and determine the gain adjustment to be performed. Using a smartphone to record the signal makes the measurement more complex. Firstly, the synchronisation between the playback and the recording required to measure the delay does not exist. Secondly, smartphones include huge variety of microphones with heterogeneous transfer functions. In order to perform precise measurements, the calibration system must obtain the transfer function to provide precise sound pressure level measurements. However, this transfer function is not always easily available.

It can therefore be appreciated that there is a need for a solution for calibration of multichannel audio systems that addresses at least some of the problems of the prior art. The present disclosure provides such a solution.

### SUMMARY

The present disclosure is about a method and an apparatus for adjusting gain and delay parameters for calibrating a multi-channel audio system composed of an audio processing device connected to a set of loudspeakers. The calibration is performed using a wireless calibration device such as a smartphone or a tablet. The calibration method adapts to a variety of different calibration devices with different audio capture characteristics and particularly different microphone transfer functions.

A calibration process comprises emitting a plurality of test tones on a plurality of loudspeakers with predetermined timings and amplitudes, according to a calibration signal. The calibration device captures the audio signal corresponding to the test tones from the listener's position. The captured audio signal is analyzed, either by the calibration device or the audio processing device, to determine the delays between loudspeakers and difference of levels between loudspeakers. Corresponding delay and gain parameters are determined and used by the audio processing device to correct the sound to be played back.

In a first aspect, the disclosure is directed to a method for adjusting gain parameters for calibrating a multichannel audio system including an audio processing device connected to a set of loudspeakers, the method comprising: obtaining an audio calibration signal emitted by the set of loudspeakers and captured by at least one microphone, the audio calibration signal comprising a plurality of test tones, each test tone emitted at a transmission time by a corresponding loudspeaker such that test tones do not overlap, each test tone comprising a plurality of parts with different amplitudes, each part comprising a signal with constant amplitude level and varying frequency; determining an amplitude level of each part of the plurality of parts of the plurality of test tones of the captured audio calibration signal; selecting a set of parts, one for each test tone, so that the cumulated difference of amplitude levels between the set of parts is minimized; and for each loudspeaker, adjusting gain parameter to compensate for relative amplitude level differences between corresponding test tone and said selected set of parts.

In a second aspect, the disclosure is further directed to a method for adjusting delay parameters, the method comprising measuring arrival times of the captured test tones of the audio signal relative to a reference arrival time; determining the relative propagation delay from each loudspeaker, the reference arrival time being the arrival time of a chosen test tone; adjust delay parameters of the loudspeakers to compensate for the relative propagation delay. In a variant embodiment, the delay adjustment for each loudspeaker is determined by subtracting to the determined relative propagation delay of each loudspeaker the delay of the highest relative propagation delay.

In a third aspect, the disclosure is directed to an apparatus for adjusting gain parameters for calibrating a multichannel audio system including an audio processing device connected to a set of loudspeakers, comprising: at least one processor configured to: obtain an audio calibration signal emitted by the set of loudspeakers and captured by at least one microphone, the audio calibration signal comprising a plurality of test tones, each test tone emitted at a transmission time by a respective loudspeaker such that test tones do not overlap, each test tone comprising a plurality of parts with different amplitudes, each part comprising a signal with constant amplitude level and varying frequency; determine an amplitude level of each part of the plurality of parts of the plurality of test tones of the captured audio calibration signal; select a set of parts, one for each test tone, so that the cumulated difference of amplitude levels between the set of parts is minimized; and for each loudspeaker, adjust gain parameter to compensate for relative amplitude level differences between corresponding test tone and said selected set of parts, and a memory configured to store at least the captured audio signal.

In a fourth aspect, the disclosure is directed to an apparatus for further adjusting delay parameters, wherein the processor is further configured to: measure arrival times of the captured test tones of the audio signal relative to a reference arrival time to determine the relative propagation delay from each loudspeaker, the reference arrival time being the arrival time of a chosen test tone; and adjust delay parameters of the loudspeakers to compensate for the relative propagation delay.

In a variant embodiment of third and fourth aspects, the apparatus further comprises at least a microphone configured to capture the audio signal emitted by the set of loudspeakers. In a variant embodiment of first and third aspects, the minimization of cumulated difference further comprises, for each part of each test tone, taking said part as reference part, determining the cumulated sum of differences between the amplitude level of said reference part and amplitude levels of parts of each other tones that is closest of the amplitude level of said reference part and determining a set of parts, one for each test tone, that provides the smallest cumulated sum of differences. In a further variant embodiments of first and third aspects, the method for determining gain adjustment parameters is performed multiple times with decreasing amplitude variations of the plurality of parts until the cumulated sum is lower than a threshold. In a variant embodiment of second and fourth aspects, the reference arrival time is determined by detecting a signal comprising the superposition of two sine signals of two different frequencies.

In a fifth aspect, the disclosure is directed to a signal for calibrating a multichannel audio system including an audio processing device connected to a set of loudspeakers, characterized in that it carries at least a first test tone to be played back on a first loudspeaker, a plurality of second test tones to be played back on a plurality of loudspeakers of the set of loudspeakers and a plurality of third test tones to be played back on the plurality of loudspeakers of the set of loudspeakers, each test tone being emitted at a predetermined transmission time and having predetermined shape and duration, each third test tone of the plurality of third test tones comprises at least 3 parts of different determined amplitudes, each part comprising a signal with constant amplitude and varying frequency. In a variant embodiment of fifth aspect, the first test tone is composed of the superposition of two sine signals of different frequencies. In a variant embodiment, each second test tone of the plurality of second test tones is comprising a sine sweep with varying frequency between a first determined frequency and a second determined frequency.

In a sixth aspect, the disclosure is directed to a computer program comprising program code instructions executable by a processor for implementing any embodiment of the method of the first and second aspects. In a seventh aspect, the disclosure is directed to a computer program product which is stored on a non-transitory computer readable medium and comprises program code instructions executable by a processor for implementing any embodiment of the method of the first and second aspects.

### BRIEF DESCRIPTION OF DRAWINGS

Preferred features of the present disclosure will now be described, by way of non-limiting example, with reference to the accompanying drawings, in which:

FIG. 1A illustrates an example calibration device according to the present principles;

FIG. 1B illustrates an example audio processing device according to the present principles;

FIG. 2A illustrates an example interconnection between the devices in the preferred implementation of the disclosure in a 5.1.2 loudspeaker setup;

FIG. 2B represents a top view of an example setup of a listening room corresponding to a 5.1.2 configuration.

FIG. 3A represents a sequence diagram describing steps required to implement a method of the disclosure under control of the calibration device, in an example configuration with three loudspeakers;

FIG. 3B represents a sequence diagram describing steps required to implement a method of the disclosure under control of the audio processing device, in an example configuration with three loudspeakers;

FIG. 3C represents a sequence diagram detailing steps required to provide the test tones composing the calibration signal in an example configuration with three loudspeakers, corresponding to step 318 in FIGS. 3A and 3B;

FIGS. 4A, 4B and 4C represent the calibration signals provided to the loudspeakers, in an example configuration with three loudspeakers;

FIG. 4D represents an alternate example of calibration signal;

FIG. 5A illustrates a first part of the signal captured by the microphone of the calibration device, related to the delay measurement, in an example configuration with three loudspeakers;

FIG. 5B illustrates the result of the application of the generated inverse filter to the first part of the signal captured by the microphone of the calibration device in an example configuration with three loudspeakers and illustrates the technique used to determine the delay parameter to be applied for each loudspeaker;

FIG. 5C illustrates a second part of the signal captured by the microphone of the calibration device, related to the amplitude measurement, in an example configuration with three loudspeakers;

FIG. 5D illustrates amplitude levels determined from the second part of signal captured by the microphone of the calibration device, in an example configuration with three loudspeakers

FIG. 6A depicts a flowchart describing steps required to determine the delay parameter for each loudspeaker; and

FIG. 6B depicts a flowchart describing steps required to determine the gain parameter for each loudspeaker.

### DESCRIPTION OF EMBODIMENTS

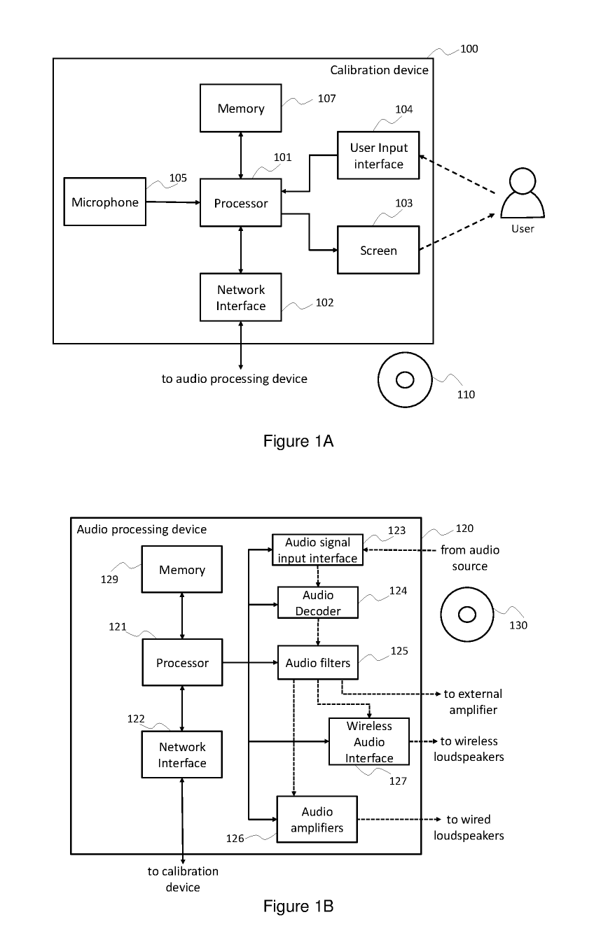

FIG. 1A illustrates an example calibration device 100 according to the present principles. The skilled person will appreciate that the illustrated device is simplified for reasons of clarity. According to a specific and non-limiting embodiment of the principles, the calibration device 100 comprises at least one hardware processor 101 configured to execute the method of at least one embodiment of the present disclosure, a network interface 102 configured to interact with other devices such as audio processing device (120 in FIG. 1B), a screen 103 configured to interact with the user by displaying information at least related to the calibration application, a user input interface 104 configured to received input from the user, a microphone 105 configured to capture an audio signal and a memory 107 configured to store at least the results of the measures performed on the device environment. A non-transitory computer readable storage medium 110 stores computer readable program code comprising at least a calibration application that is executable by the processor 101 to perform the calibration operation according to the present principles.

One example of calibration device is a smartphone. Another example of calibration device is a tablet. Many other such calibration devices may be used. A touch interface is one example of user input interface. A keyboard is another one. Many other such user input interfaces may be used. Conventional communication interfaces such as Wifi or Bluetooth are examples of network interface 102. Other network interfaces may be used. These network interfaces may provide support for higher level protocols such as various Internet protocols, data exchange protocols or device interoperability protocols such as AllJoyn in order to allow the calibration device 100 to interact with the audio processing device 120.

FIG. 1B illustrates an example audio processing device 120 according to the present principles. The skilled person will appreciate that the illustrated device is simplified for reasons of clarity. According to a specific and non-limiting embodiment of the principles, the audio processing device 120 comprises at least one hardware processor 121 configured to execute the method of at least one embodiment of the present disclosure, a network interface 122 configured to interact with other devices such as calibration device 100, an audio signal input interface 123 configured to receive the audio signal to be rendered to the listener, an audio decoder 124 configured to decode the audio signal, a plurality of audio filters 125 configured to adjust the decoded audio signal according to the calibration parameters determined for each loudspeaker, a plurality of audio amplifiers 126 configured to amplify the audio signal in order to deliver the amplified decoded signal to loudspeakers, at least a wireless audio interface 127 configured to provide wirelessly the decoded audio signal to at least a wireless amplified loudspeaker and a memory 129 configured to store at least the calibration parameters for each loudspeaker. The decoded audio signal is also directly available on a connector in order to be rendered by an external amplifier or a (wired) amplified loudspeaker, which is generally the case for subwoofers. A non-transitory computer readable storage medium 130 stores computer readable program code comprising at least a calibration application that is executable by the processor 121 to perform the calibration operation according to the present principles.

In a preferred embodiment, the input source comes from an external device. Multiple different devices are able to provide an audio signal, including a cable receiver, a satellite receiver, any means to receive digital television including “over-the-top” devices well-known by the skilled in the art, a mass storage device such as a USB external hard disk drive or USB key. The audio signal can also be delivered through the Internet through streaming mechanisms using appropriate network connection and protocols.

In a variant, the audio processing device 120 not only handles audio but also video. In this case, in addition to the modules described in FIG. 1B, an additional demultiplexer module splits the incoming audio-video signal to separate the audio from the video. The audio signal is handled as described above. The video signal is decoded by an appropriate video decoder and provided to the display interface. In another variant, the audio processing device 120 integrates also the front end module allowing the reception of a broadcast signal and therefore providing the audio-video signal, such front end module comprising at least one of a cable tuner, a satellite tuner, and an Internet gateway.

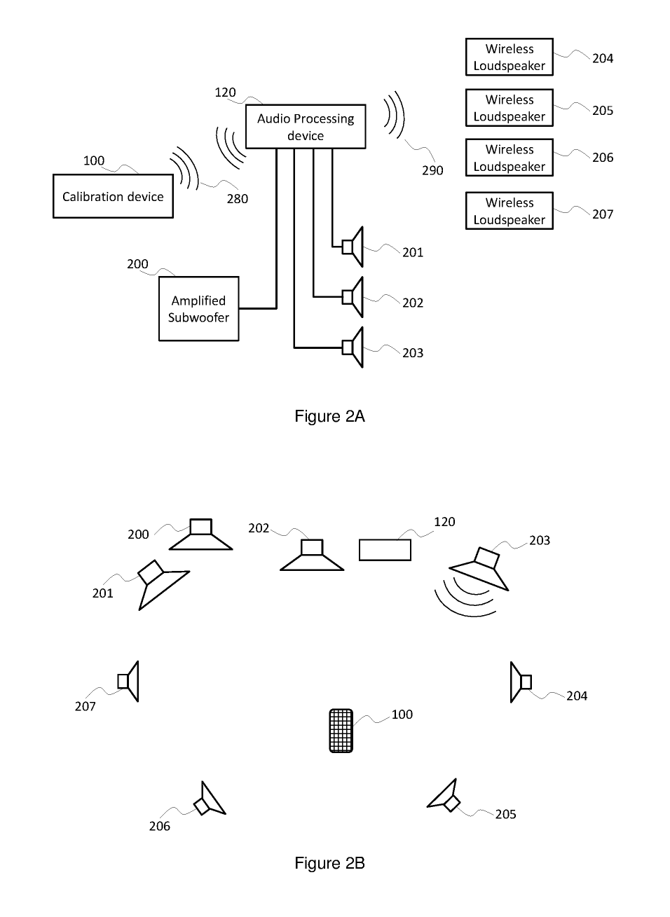

FIG. 2A illustrates an example interconnection between the devices of the preferred implementation of the disclosure in a 5.1.2 loudspeaker setup. The calibration device 100 is connected to the audio processing device 120 through wireless network connection 280. A set of loudspeakers 201, 202, 203 are connected to the audio processing device 120 and benefit from the integrated amplifier. An amplified subwoofer 200 is connected to the audio processing device through a non-amplified connection. Wireless loudspeakers 204, 205, 206 and 207 are connected wirelessly to the audio processing device 120 through the wireless loudspeaker connection 290. Conventionally, wireless loudspeakers comprise a wireless audio interface configured to receive the audio signal through a wireless carrier and deliver the audio signal to an audio amplifier configured to amplify the audio signal and deliver it to an integrated loudspeaker that will generate the sound waves corresponding to the incoming wireless audio signal. The person skilled in the art will appreciate that both the network connections and the loudspeaker connections can either be wired or wireless and many different combination of wired and wireless are possible. In a preferred embodiment, the network connection 280 uses Wifi while the wireless loudspeaker connections use a proprietary solution in the 2.4 GHz band carrying uncompressed audio or lossless compressed audio. Other type of networks may be used.

FIG. 2B represents a top view of an example setup of a listening room corresponding to a 5.1.2 configuration. The listening room is equipped with an audio processing device 120 and a set of loudspeakers comprising the subwoofer 200, front left 201, center 202, front right 203, ceiling right 204, rear right 205, rear left 206 and ceiling left 207 loudspeakers. The user is using a smartphone as calibration device 100. The figure illustrates one step of the calibration phase where a test tone is played back by the audio processing device 120 on the front right loudspeaker 203 and the corresponding sound is recorded by the calibration device 100. Further operations are described in the next paragraphs.

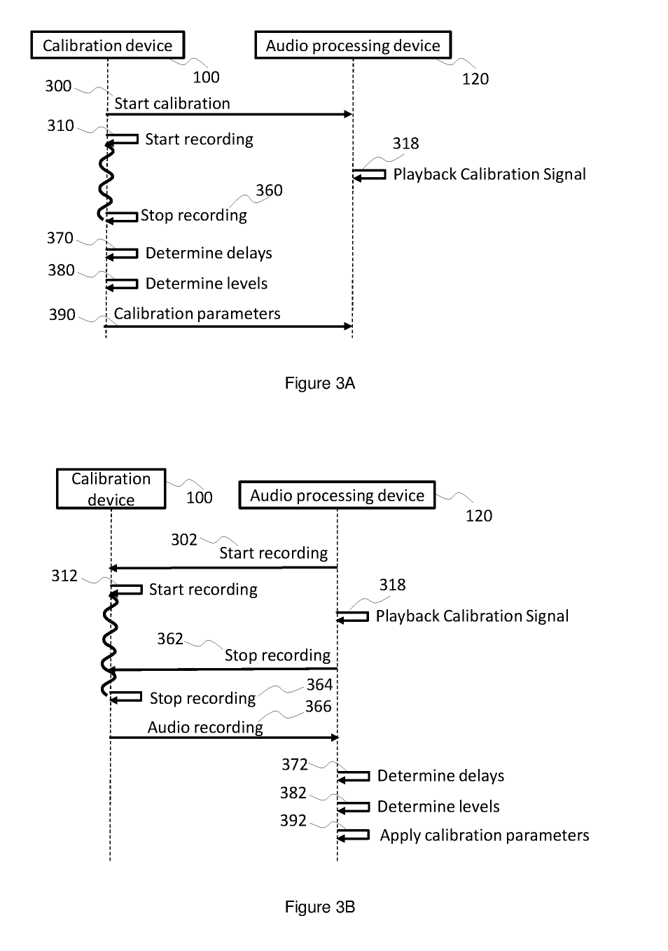

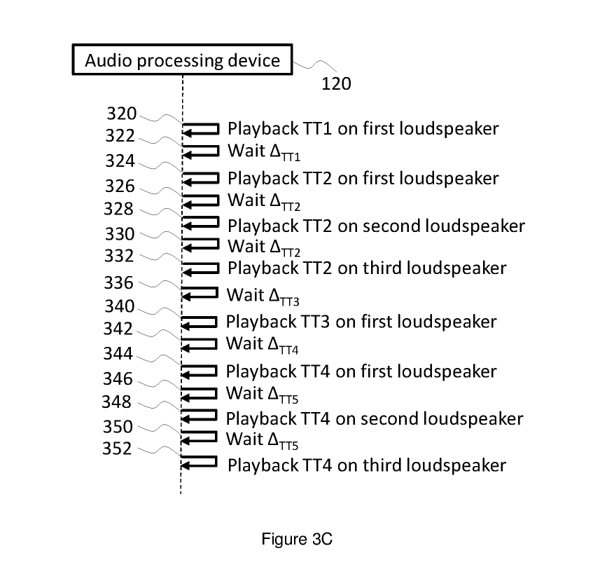

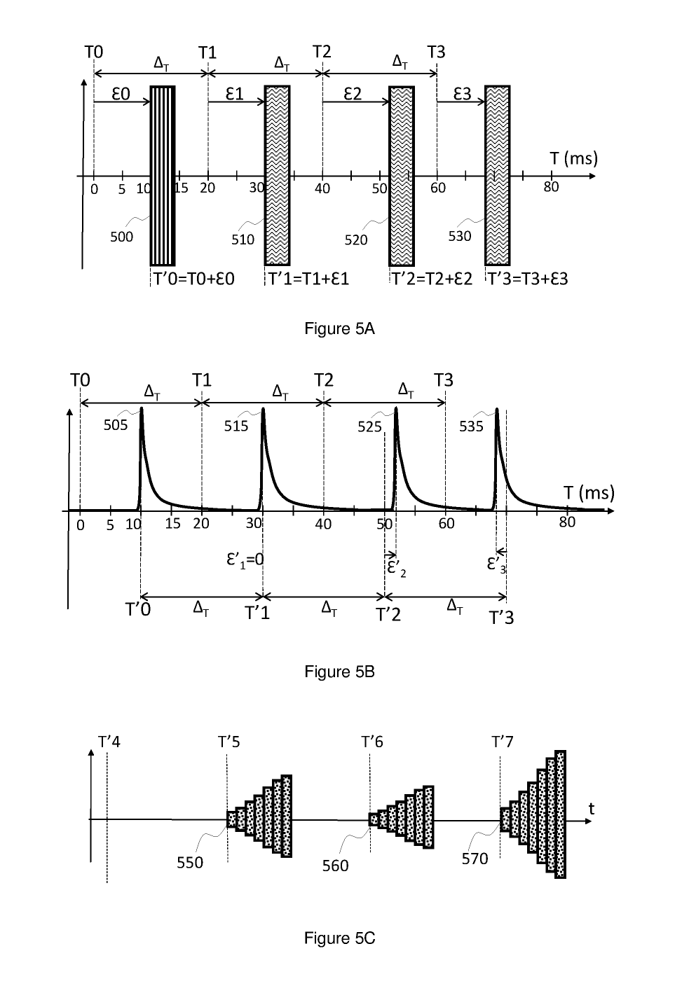

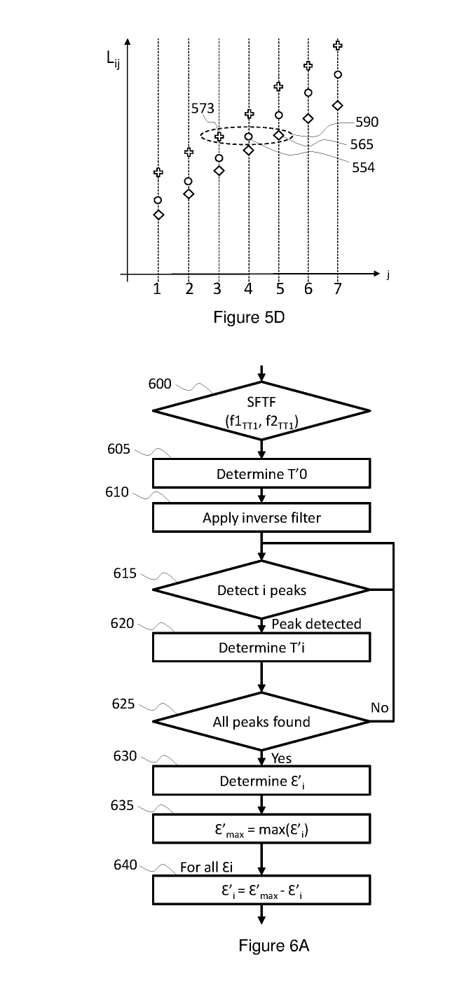

FIG. 3A represents a sequence diagram describing steps required to implement a method of the disclosure under control of the calibration device, in an example configuration with three loudspeakers. In step 300, the calibration device 100 requests the audio processing device 120 to start the calibration and, in step 310, starts to record the audio signal captured by the microphone (105 in FIG. 1A). In step 318, the audio processing device emits the test tones composing the calibration signal on the plurality of loudspeakers as detailed below in the description of FIG. 3C. In step 360, the calibration device 100 stops recording. The calibration device 100 is able to determine easily the required length of the audio capture since the number of loudspeakers is known as well as the length of the test tones and the delays. In step 370, the captured signal is analysed to determine the delays. This operation is detailed in the description of FIG. 5B. In step 380, the captured signal is analysed to determine the signal levels. This operation is detailed in the description of FIG. 5C. In step 390, the calibration device 100 provides to the audio processing device 120 the calibration parameters at least comprising the delay and gain adjustments to be applied to each loudspeaker.

In the preferred embodiment, the determination of the audio parameters are performed in the calibration device 100, as illustrated by FIG. 3A. In an alternate embodiment, the determination of the audio parameters is computed in the audio processing device 120, as illustrated by FIG. 3B. As will be seen, such an embodiment further comprises providing the appropriate data from the calibration device 100 to the audio processing device 120.

FIG. 3B represents a sequence diagram describing steps required to implement the disclosure under control of the audio processing device, in an example configuration with three loudspeakers. In step 302, the audio processing device 120 requests the calibration device 100 to start recording. In step 312, the calibration device 100 starts to record the audio signal captured by the microphone (105 in FIG. 1A). In step 318, the audio processing device emits the test tones composing the calibration signal on the plurality of loudspeakers as detailed below in the description of FIG. 3C. Then, in step 362, the audio processing device 120 requests the calibration device 100 to stop recording. In step 364, the recording is stopped and the calibration device 100 provides the recorded audio signal to the audio processing device 120 in step 366. In step 372, the captured signal is analysed to determine the delays and in step 382, the captured signal is analysed to determine the signal levels. The delay and gain adjustments are then directly applied in step 392 by the audio processing device.

To simplify the description, an example configuration with three loudspeakers is used in the further description, only using the front centre loudspeaker 202, front left loudspeaker 201 and front right loudspeaker 203 of FIG. 2B. The person skilled in the art will appreciate that the principles apply to more complex setups.

FIG. 3C represents a sequence diagram detailing steps required to provide the test tones composing the calibration signal in an example configuration with three loudspeakers, corresponding to step 318 in FIGS. 3A and 3B. In step 320, the audio processing device 120 starts the playback of a first test tone TT1 on a first loudspeaker, say the centre loudspeaker 202 of FIG. 2B. After the completion of the playback of the first test tone TT1, in step 322, the audio processing device 120 waits for a determined amount of time Δ_{TT1}. In step 324, the audio processing device 120 starts the playback of a second test tone TT2 on the first loudspeaker (centre loudspeaker 202 of FIG. 2B). The device waits for a determined amount of time Δ_{TT2}, in step 326. The process iterates in step 328 by playing back the second test tone TT2 on the second loudspeaker (left loudspeaker 201 of FIG. 2B) and waiting for Δ_{TT2} in step 330. In step 332, the audio processing device 120 starts the playback of a second test tone TT2 on the third loudspeaker (right loudspeaker 203 of FIG. 2B). Thus, the second test tone TT2 has been played back on each loudspeaker of the audio system, at precise timings after the playback of the first test tone. In step 336, the audio processing device 120 waits for a determined amount of time Δ_{TT3}. In step 340, the audio processing device 120 starts the playback of a third test tone TT3 on the first loudspeaker and waits, in step 342 for a determined amount of time Δ_{TT4}. In step 344, the audio processing device 120 starts the playback of a fourth test tone TT4 on the first loudspeaker and waits, in step 346 for a determined amount of time Δ_{TT5}. In step 348, the audio processing device 120 starts the playback of a fourth test tone TT4 on the second loudspeaker and waits, in step 350 for a determined amount of time Δ_{TT5}. In step 352, the audio processing device 120 starts the playback of a fourth test tone TT4 on the third loudspeaker.

In the preferred embodiment, the delays between test tones, namely Δ_{TT1}, Δ_{TT2}, Δ_{TT3}, Δ_{TT4} and Δ_{TT5} are determined so that the test tones are played back at regular intervals, for example 500 ms, noted Δ_{T}. This facilitates the computation of the timings in the analysis of the captured signal.

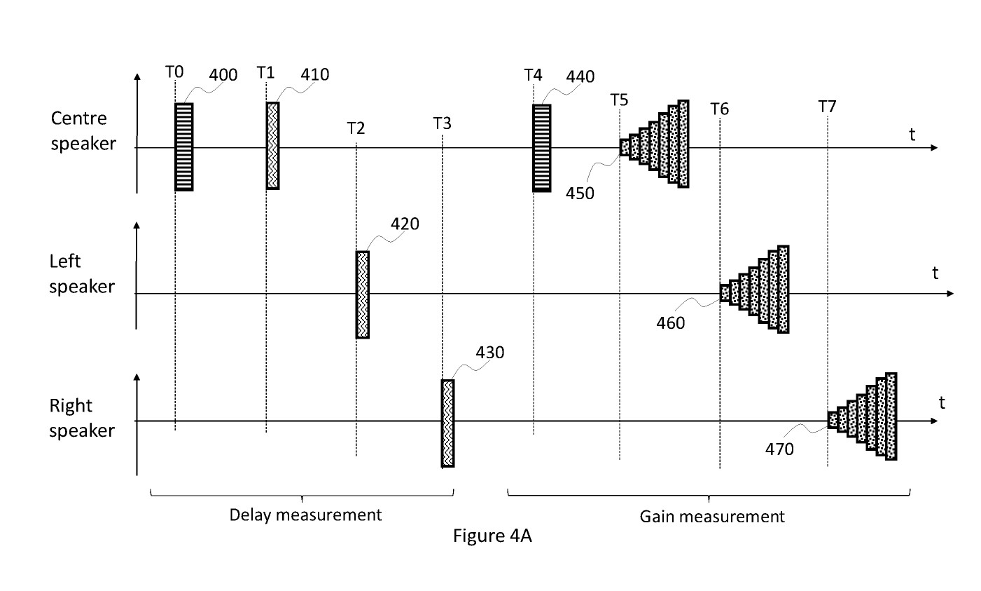

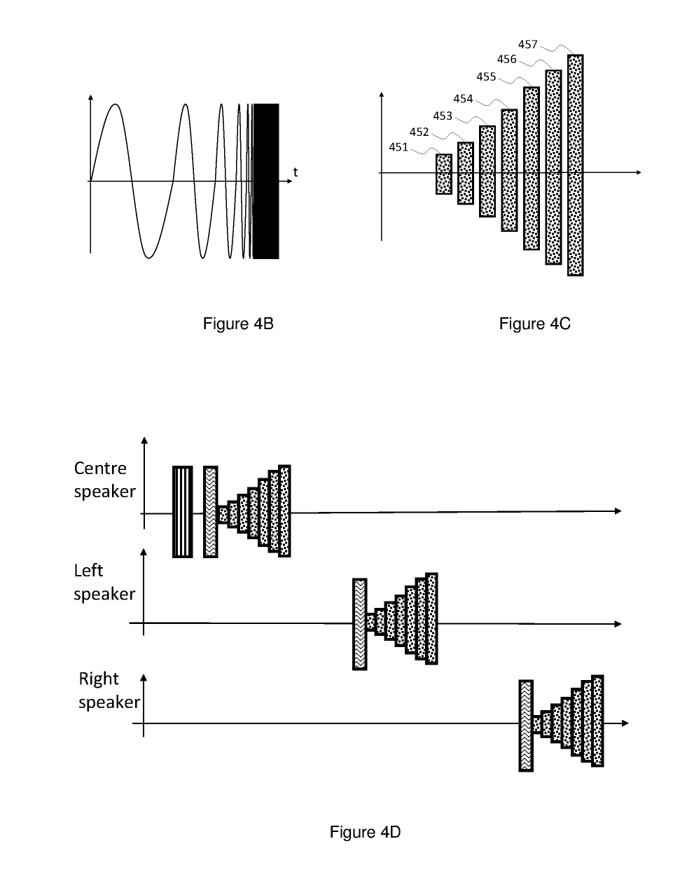

FIG. 4A, 4B and 4C represent the calibration signals provided to the loudspeakers, in an example configuration with three loudspeakers. In FIG. 4A, a first test tone TT1 400 is played back at time TO, corresponding to step 320 of FIG. 3A and 3B, and serves as reference for the delays measurements. The first test tone TT1 is the superposition of two sine signals at different frequencies f1_{TT1} and f2_{TT1} for a duration of Δ_{TT1}. Examples of values are f1_{TT1}=1 kHz, f2_{TT1}=2 kHz and Δ_{TT1}=100 ms. Another example of values are f1_{TT1}=500 Hz, f2_{TT1}=4 kHz and =Δ_{TT1}=1 s. A plurality of second test tones TT2 410, 420, 430 are played back successively on each of the loudspeakers each time after a determined delay, respectively at T1, T2 and T3. The second test tone TT2, illustrated in FIG. 4B, comprises a sine signal with exponentially varied frequency, generated as follows:

$$y = sin ( 2 π \times ( \frac{{f}_{1 TT 2}}{a} ) \times ( {e}^{t \times a} - 1 ) ) with a = \frac{log ( \frac{{f}_{2 TT 2}}{{f}_{1 TT 2}} )}{T}$$

wherein the sweep starts at frequency f_{2TT1}, for example f_{2TT1}=22 Hz, ends at angular frequency f_{2TT2}, for example f_{2TT2}=22 KHz and for a duration of T, for example T=0.25 s.

A third test tone TT3 440 is played back at time T4, corresponding to step 340 of FIGS. 3A and 3B, and serves as reference for the gain measurements. This test tone relies on the same principle as the first test tone but preferably uses different frequencies f1^{TT3} and f2_{TT3} in order to differentiate the two parts of the calibration signal. A plurality of fourth test tones TT4 450, 460, 470 are played back successively on each of the loudspeakers each time after a determined delay, respectively at T5, T6 and T7.

The fourth test tone TT4 is composed of a sequence of multiple unitary parts with varying levels of power. In the preferred embodiment, as shown in FIG. 4C, each unitary part is composed of white noise and is repeated multiple times, for example 7 times 451 to 457, with increasing power levels. A rest duration Δ_{R}, during which no signal is emitted preferably separates two successive unitary parts. These different levels of the unitary parts allow further relative comparisons and allow to adjust gain without relying on absolute power level values captured by microphone with unknown transfer function. In the preferred embodiment, the difference of levels between consecutive unitary parts is constant, noted Δ_{L} and equal to 1 dB. For example, the difference between the unitary part 451 and the unitary part 454 is 3×1 dB=3 dB. In an alternate embodiment, the power levels are decreasing. In various alternate embodiment, the variation of power level between unitary parts is not constant but is linear, exponential or is defined by a function. Many other types of variants can be used.

The man skilled in the art will appreciate that many variations in the structure of the calibration signal can be implemented. For example, in an alternate embodiment, the test tones may be grouped by loudspeakers, therefore playing back the successively test tone TT4 after TT2 for a given loudspeaker before addressing the next loudspeaker. In this situation TT3 is omitted and the steps to determine the delay and gain adjustments need to be adapted accordingly for the calculation of the different timings. Such calibration signal is illustrated in FIG. 4D.

In another embodiment, other types of signals than sinusoids are used for TT1 and TT3. In an alternate embodiment, TT3 uses the same frequencies as TT1 and therefore is identical. In another embodiment, TT3 is omitted and TT1 is used as temporal reference for both parts of the calibration signal. In another embodiment, TT1 is omitted and the first occurrence of TT2 serves as temporal reference.

FIG. 5A illustrates a first part of the calibration signal captured by the microphone of the calibration device, related to the delay measurement, in an example configuration with three loudspeakers. It represents the capture 500 of the first test tone TT1 played back on the centre speaker and received at T0+ε0=10 ms, the capture 510 of the second test tone TT2 played back on the centre speaker and received at T1+ε1=30 ms, the capture 520 of the second test tone TT2 played back on the left speaker and received at T2+ε2=52 ms, and the capture 530 of the second test tone TT2 played back on the right speaker and received at T3+ε3=68 ms. In this example, the left loudspeaker 201 is farther away than the centre loudspeaker while the right loudspeaker 203 is closer. This can be observed by the according delays: the capture 520 is behind schedule of 2 ms while the capture 530 is in advance of 2 ms compared to the capture 510.

The person skilled in the art will appreciate that the values used for the example of FIGS. 5A and 5B are for illustration purposes only. In practise, values are much greater to avoid overlaps between the different test tones when speaker are farther away, and to enable easy identification of the signals in the captured signal. In a more realistic implementation, for example, the duration of the test tone TT1 and TT2 is respectively 100 ms and 250 ms and the time between two successive test tones is 500 ms. Such values however cannot be used to illustrate visually the temporal differences. Therefore, smaller values are used in FIGS. 5A and 5B to facilitate the understanding of the disclosure principles.

The analysis is performed on sampled digital data corresponding to the recorded signal. When the device integrates multiple microphones, the signals of these microphones are averaged to provide a single signal.

A first operation comprises the determination of the delays. The first test tone TT1 and the plurality of second test tones TT2 are analysed differently. A short-time Fourier transform (SFTF) is applied on the signal until two peaks at frequencies f1_{TT1} and f2_{TT1} are found without signal elsewhere. When these frequencies are detected, the corresponding time becomes the temporal reference for the captured signal, corresponding to T′0 in FIG. 5B. Then the deconvolution of the impulse response is realized by linearly convolving the output of the measured system with an inverse filter. The inverse filter is generated in the following manner. The sine sweep is temporally reversed and then delayed in order to obtain a causal signal. For that, the reversed signal is pulled back in the positive region of the time axis. This time reversal causes a sign inversion in the phase spectrum. As such, the convolution of this reversed version of the excitation signal with the initial sine sweep will lead to a signal characterized by a perfectly linear phase corresponding to a pure delay but introduces a squaring of the magnitude spectrum. Therefore, the magnitude spectrum of the resulting signal is then divided by the square of the magnitude spectrum of the initial sine sweep signal. Applying this inverse filter to the captured signal generates the impulse response that characterises the particular room setup as well as the whole system, taking into account room and furniture absorptions and reflections but also delays due to the use of a wireless transmission.

FIG. 5B illustrates the result of the application of the generated inverse filter to the first part of the signal captured by the microphone of the calibration device in an example configuration with three loudspeakers and illustrates the technique used to determine the delay parameter to be applied for each loudspeaker. On this signal, the peaks 505, 515, 525 and 535 correspond temporally to the beginning of each of the second test tones.

The delay of each peak is measured from T′0, the time of reception of the first test tone and the modulo of Δ_{T} is taken, allowing to compute respectively ε′₁, ε′₂ and ε′₃ that represent the delays between the expected arrival of the test tone if the loudspeaker was at same distance than the loudspeaker emitting the first test tone and the measured arrival:

ε′ᵢ=(T′i−T′0) modulo Δ_{T}

The value of these delays reflect not only the distance according to the propagation speed of sound but also variations from the different audio paths (i.e. wired or wireless channels). In the example of FIG. 5B, ε′₁=0 since the corresponding signal is played back on the same loudspeaker as the reference signal, ε′₂=2 ms, indicating than the test tone emitted by the left loudspeaker arrives later than expected, meaning that the left loudspeaker is farther away from the listening position than the centre loudspeaker and ε′₃=−2 ms, the negative value indicating than the right loudspeaker is closer to the listening position than the centre loudspeaker. In the preferred embodiment the loudspeaker with highest ε′ value is selected as reference and no delay will be applied to it since it corresponds to the farthest loudspeaker. Delays will be applied to the loudspeakers closer than the farthest one. The delay parameter to be applied to each other loudspeaker is computed by subtracting the delay of each other loudspeaker to the delay of the reference speaker. In the example of FIG. 5B, the left loudspeaker is taken as reference so that a delay of ε′₂−ε′₁=2 ms is applied to the center loudspeaker and a delay of ε′₂−ε′₃=4 ms is applied to the right loudspeaker.

A second operation comprises the determination of the gain. FIG. 5C illustrates the result of the capture of a second part of the calibration signal by the microphone of the calibration device, related to the amplitude measurement, in an example configuration with three loudspeakers. It shows that the signal levels 570 of the right (third) loudspeaker are higher than those 550 of the center (first) loudspeaker, themselves higher than those 560 of the left (second) loudspeaker. The amplitude level of each unitary part for each loudspeaker is noted Lᵢⱼ where i indicates the index of loudspeaker and j indicates the index of the unitary part, both indexes starting from one. By using the timing information ε′ᵢ gathered during the delay measurement process, the device can separate each unitary part of test tone TT4 for each loudspeaker by using a capture window. A slight margin, for example of value Δ_{R}/2, in the width of the capture window is preferably used, benefiting from the rest duration that is preferably existing between successive unitary parts. To determine the amplitude level Lᵢⱼ of unitary part j for loudspeaker i, all samples between T′₄+(j×Δ_{T})−Δ_{R}/2 and T′₄+(j×Δ_{T})+Δ_{R}/2+β, β being the duration of a unitary part, are selected.

Their absolute values are summed up and the result is divided by β. According to usual practice in the domain, the logarithmic value is taken and multiplied by 20 to get a decibel value. To summarize:

$${L}_{ij} = 20 \times log ( \frac{\sum \vert sample\_value \vert}{β} )$$

FIG. 5D illustrates the amplitude levels determined from the second part of the signal captured by the microphone of the calibration device, in an example configuration with three loudspeakers. In this figure, the horizontal axis identifies the index of the unitary parts, the vertical axis corresponds to the level determined for each loudspeaker for all unitary parts according to the method described in previous paragraph. The circle symbol represents values L₁ⱼ corresponding to the center (first) loudspeaker, the diamond symbol represents values L₂ⱼ corresponding to the left (second) loudspeaker and the cross symbol represents values L₃ⱼ corresponding to the right (third) loudspeaker. The FIG. 5D reflects the difference of captured levels, as previously shown in FIG. 5C. The difference between all determined values are computed and a set of values is selected, comprising one value for each loudspeaker, chosen so that the difference between the selected values is minimal. In FIG. 5C, the values chosen are L₁₄ 554, L₂₅ 565 and L₃₃ 573. This set of values 590 is chosen since it delivers the smallest difference between the levels. This choice determines the gain adjustment required to obtain a well-balanced audio setup. A first strategy is to increase the level of the loudspeakers with smaller levels. In this case the reference is the speaker with the highest level, here the right (third) loudspeaker. Therefore the level of the center (first) loudspeaker must be increased by Δ_{L} since the value chosen for the center (first) loudspeaker corresponds to the sine sweeps with the next index compared to the reference speaker and the level of the left (second) loudspeaker must be increased by 2×Δ_{L} since the difference between the index of the value chosen for the left (second) loudspeaker and the index of the reference value is 2. Another strategy is to decrease the level of loudspeakers with the highest levels in order to adjust to the smallest level. In this case, it is the inverse operation: the value of the left (second) loudspeaker is unchanged, the value of the right (third) loudspeaker is decreased by 2×Δ_{L} and the value of the center (first) loudspeaker is decreased by Δ_{L}. We have adopted this strategy as in digital audio attenuation provides better quality than amplification.

The delay and gain adjustment parameters determined according to the present principles are then applied by the audio processing device 120 in the audio filters 125, providing a well calibrated sound to the listener.

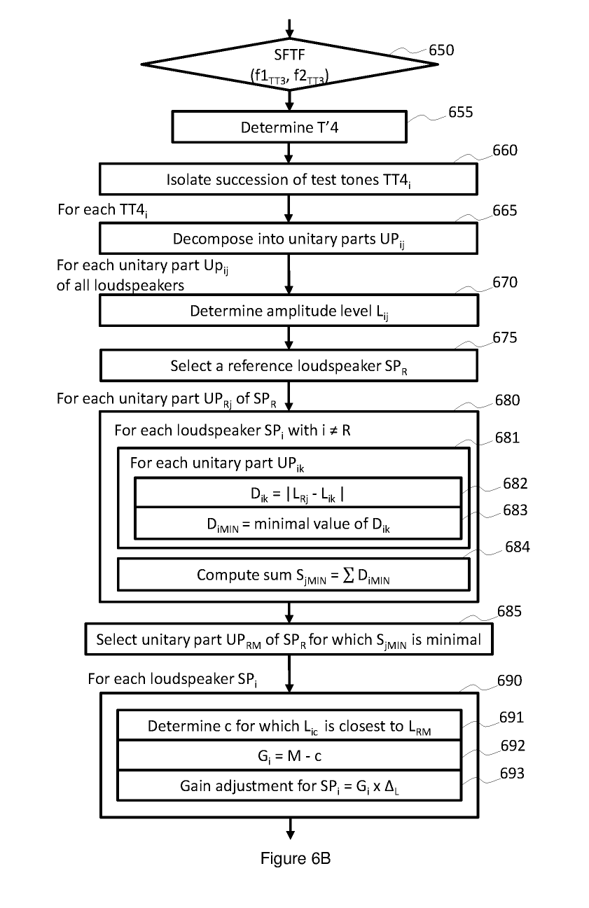

FIGS. 6A depicts a flowchart describing steps required to determine the delay parameter for each loudspeaker. This flowchart can be implemented either by the calibration device 100 or by the audio processing device 120. It corresponds to the analysis of the signal illustrated in FIG. 5A. In step 600, a short-time Fourier transform (SFTF) is applied on the signal until two peaks at frequencies f1_{TT1} and f2_{TT1} are detected. When these frequencies are detected, the corresponding time becomes the temporal reference for the captured signal, in step 605, corresponding to T′0 in FIG. 5B. In step 610, the inverse filter generated as described above is applied to the remaining part of the signal, resulting in the signal illustrated in FIG. 5B. In step 615, the peaks are detected. Each peak corresponds to a different loudspeaker. For each peak detected in step 620, the corresponding time value T′i is determined. This is repeated until, in step 625, all peaks are found. Then, in step 630, the delays ε′ᵢ are determined using the following computation: ε′ᵢ=(T′i−T′0) % Δ_{T} with i being the index number of the loudspeaker in the set of loudspeakers. Some ε′ᵢ values may be negative since some loudspeakers may be closer to the listener than the center (first) loudspeaker used to playback the first test tone TT1. Since it is not possible to apply negative delays, the ε′ᵢ values need to be transposed. First, the maximal value of ε′ᵢ is found, in step 635 and all the ε′ᵢ values are then subtracted from this maximal value, in step 640. This results in a null delay for the farthest loudspeaker.

FIG. 6B depicts a flowchart describing steps required to determine the gain parameter for each loudspeaker. This flowchart can be implemented either by the calibration device 100 or by the audio processing device 120. In step 650, a short-time Fourier transform (SFTF) is applied on the signal until two peaks at frequencies f1_{TT3} and f2_{TT3} are detected. When these frequencies are detected, the corresponding time becomes the temporal reference for the captured signal, in step 655, corresponding to T′4 in FIG. 5C. In step 660, the test tones TT4ᵢ for each loudspeaker i are isolated using the timing information determined during the steps to determine the delay parameter. In step 665, each of these test tone is decomposed according to the description of FIG. 5C, into j unitary parts UPᵢⱼ of varying amplitude levels. The amplitude level Lᵢⱼ for each unitary sine sweep is measured, in step 670, as previously detailed in the description of FIG. 5C. In step 675, a reference loudspeaker SP_{R} is chosen. In one embodiment, the loudspeaker with highest amplitude levels is chosen. In another embodiment, the loudspeaker with smallest amplitude levels is chosen. In yet another embodiment, all further steps 680 to 684 are performed for each loudspeaker and the loudspeaker for which the cumulated sum S_{jMIN} is the smallest is selected as reference loudspeaker. Step 680 is then repeated for each unitary parts UP_{Rj} of the reference loudspeaker SP_{R}, therefore considered temporarily as a reference unitary part. It comprises the step 681 that is repeated for each loudspeaker SPᵢ other than SP_{R}. For each unitary part UPᵢₖ of loudspeaker SPᵢ, in step 682, the absolute value Dᵢₖ of the amplitude difference between the reference unitary part UP_{Rj} and the unitary part UPᵢₖ is determined. The minimal value of all amplitude differences for the speaker SPᵢ is determined, in step 683, as D_{iMIN}. In step 684, the sum of all D_{iMIN} is computed and noted S_{jMIN}. When all S_{jMIN} have been computed for all unitary parts UP_{Ri} of the reference loudspeaker SP_{R}, the unitary part for which this cumulated sum of differences is minimal is selected UP_{RM}, in step 685. This selects the reference amplitude L_{RM} that delivers best results since the differences are minimal, so that the corresponding gain adjustments introduce minimal approximation errors. Step 690 is repeated for each loudspeaker SPᵢ. It comprises the step 691, 692 and 693. In step 691 the amplitude levels Lᵢⱼ of the unitary parts of loudspeaker SPᵢ are compared to the reference amplitude L_{RM} and the unitary part with closest amplitude level L_{ic} is chosen, determining the selected index c for loudspeaker SPᵢ. The (signed) difference of indexes Gᵢ is then determined as the difference between the two indexes, in step 692. Since in the preferred embodiment, the unitary parts are of increasing amplitude levels and the amplitude level difference between two consecutive parts is Δ_{L}, the gain adjustment is simply deduced, in step 693, by multiplying the difference of indexes Gᵢ by Δ_{L}. The smallest indexes correspond to lower amplitude levels. When Gᵢ is negative, the amplitude for loudspeaker i needs to be increased, whereas it needs to be decreased when Gᵢ is positive. In the case where the test tone contains unitary parts with different arrangements regarding amplitude level variations, the computation may be more complex but is feasible since the values are predetermined.

This process relies on the storage of the data in tables. Index and data caching is preferably performed in order to accelerate the treatment.

In a variant embodiment, the determination of the gain adjustment parameters is performed multiple times, iteratively, with decreasing values of Δ_{L}. For example, a first run is done with a first value of Δ_{L}, say 3 dB, allowing a first rough adjustment of the loudspeakers. A second run is done with a smaller level of Δ_{L}, say 1 dB and a third with 0.3 dB. Such technique provides a fine-grained adjustment of the gain levels. In another embodiment, the iteration continues with decreasing values of Δ_{L} until the gain difference between loudspeakers is smaller than a threshold. This can for example be measured by the cumulated sum S_{jMIN}.

However, for a proper gain calibration Δ_{L} value must ensure that the amplitude level range of unitary parts for each speaker are overlapping as it is the case in FIG. 5D: maximum of minimum level per speaker must be smaller than the minimum of maximum levels per speaker [Max of Minᵢ(Lᵢⱼ) smaller Min of Maxᵢ(Lᵢⱼ)].

As will be appreciated by one skilled in the art, aspects of the present principles can take the form of an entirely hardware embodiment, an entirely software embodiment (including firmware, resident software, micro-code and so forth), or an embodiment combining hardware and software aspects that can all generally be defined to herein as a “circuit”, “module” or “system”. Furthermore, aspects of the present principles can take the form of a computer readable storage medium. Any combination of one or more computer readable storage medium(s) can be utilized. It will be appreciated by those skilled in the art that the diagrams presented herein represent conceptual views of illustrative system components and/or circuitry embodying the principles of the present disclosure. Similarly, it will be appreciated that any flow charts, flow diagrams, state transition diagrams, pseudo code, and the like represent various processes which may be substantially represented in computer readable storage media and so executed by a computer or processor, whether or not such computer or processor is explicitly shown. A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information there from. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present principles can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

1. A method for adjusting gain parameters for calibrating a multichannel audio system including an audio processing device connected to a set of loudspeakers, the method comprising:
obtaining an audio calibration signal emitted by the set of loudspeakers and captured by at least one microphone, the audio calibration signal comprising a plurality of test tones, each test tone emitted at a transmission time by a corresponding loudspeaker such that test tones do not overlap, each test tone comprising a plurality of parts with different amplitudes, each part comprising a signal with constant amplitude level and varying frequency;
determining an amplitude level of each part of the plurality of parts of the plurality of test tones of the captured audio calibration signal;
selecting a set of parts, one for each test tone, so that the cumulated difference of amplitude levels between the set of parts is minimized; and
for each loudspeaker, adjusting gain parameter to compensate for relative amplitude level differences between corresponding test tone and said selected set of parts.

2. The method of claim 1 wherein the minimization of cumulated difference further comprises, for each part of each test tone, taking said part as reference part, determining the cumulated sum of differences between the amplitude level of said reference part and amplitude levels of parts of each other tones that is closest of the amplitude level of said reference part and determining a set of parts, one for each test tone, that provides the smallest cumulated sum of differences.

3. The method according to claim 1 wherein the method is performed multiple times with decreasing amplitude variations of the plurality of parts until the cumulated sum is lower than a threshold.

4. The method according to claim 1 wherein the method is further for adjusting delay parameters, the method comprising:
measuring arrival times of the captured test tones of the audio signal relative to a reference arrival time corresponding to a particular test tone comprising the superposition of two sine signals of two different frequencies;
determining a relative propagation delay from each loudspeaker, the reference arrival time being the arrival time of a chosen test tone; and
adjusting delay parameters of the loudspeakers to compensate for the relative propagation delay.

5. The method according to claim 4 wherein the delay adjustment for each loudspeaker is determined by subtracting to the determined relative propagation delay of each loudspeaker the delay of the highest relative propagation delay.

6. An apparatus for adjusting gain parameters for calibrating a multichannel audio system including an audio processing device connected to a set of loudspeakers, comprising:
at least one processor configured to:
obtain an audio calibration signal emitted by the set of loudspeakers and captured by at least one microphone, the audio calibration signal comprising a plurality of test tones, each test tone emitted at a transmission time by a respective loudspeaker such that test tones do not overlap, each test tone comprising a plurality of parts with different amplitudes, each part comprising a signal with constant amplitude level and varying frequency;
determine an amplitude level of each part of the plurality of parts of the plurality of test tones of the captured audio calibration signal;
select a set of parts, one for each test tone, so that the cumulated difference of amplitude levels between the set of parts is minimized; and
for each loudspeaker, adjust gain parameter to compensate for relative amplitude level differences between corresponding test tone and said selected set of parts, and
a memory configured to store at least the captured audio signal.

7. The apparatus according to claim 6 wherein the minimization of cumulated difference further comprises, for each part of each test tone, taking said part as reference part, determining the cumulated sum of differences between the amplitude level of said reference part and amplitude levels of parts of each other tones that is closest of the amplitude level of said reference part and determining a set of parts, one for each test tone, that provides the smallest cumulated sum of differences.

8. The apparatus according to claim 6 wherein the processor is further configured to iterate the gain adjustment multiple times with decreasing amplitude variations of the plurality of parts until the cumulated sum is lower than a threshold.

9. The apparatus according to claim 6 for further adjusting delay parameters, wherein the processor is further configured to:
measure arrival times of the captured test tones of the audio signal relative to a reference arrival time to determine the relative propagation delay from each loudspeaker, the reference arrival time being the arrival time of a chosen test tone; and
adjust delay parameters of the loudspeakers to compensate for the relative propagation delay.

10. The apparatus according to claim 6 further comprises at least a microphone configured to capture the audio signal emitted by the set of loudspeakers.

11. An audio signal for calibrating a multichannel audio system including an audio processing device connected to a set of loudspeakers, said audio signal carrying at least a first test tone to be played back on a first loudspeaker, a plurality of second test tones to be played back on a plurality of loudspeakers of the set of loudspeakers and a plurality of third test tones to be played back on the plurality of loudspeakers of the set of loudspeakers, each test tone being emitted at a predetermined transmission time and having predetermined shape and duration, wherein each third test tone of the plurality of test tones is comprising at least 3 parts of different determined amplitudes, each part comprising a signal with constant amplitude level and varying frequency.

12. The signal according to claim 11 wherein the first test tone is composed of the superposition of two sine signals of different frequencies.

13. The signal according to claim 11 wherein each second test tone of the plurality of second test tones is comprising a sine sweep with varying frequency between a first determined frequency and a second determined frequency.

14. Computer program comprising program code instructions executable by a processor for implementing the steps of a method according claim 1.

15. Computer program product which is stored on a non-transitory computer readable medium and comprises program code instructions executable by a processor for implementing the steps of a method according to claim 1.
